(19) United States
(12) Patent Application Publication
(10) Pub. No.: US 2008/0029519 A1
(43) Pub. Date: Feb. 7, 2008

(54) Pressurized fuel cylinder

(75) Inventors: James G. Sommer, Mishawaka, IN (US); Robert F. Lane, Brentwood, TN (US); Thomas B. Freeland, Brentwood, TN (US)

Correspondence Address: LANIER FORD SHAVER & PAYNE P.C., P O BOX 2087, HUNTSVILLE, AL, 35804-2087, US

(73) Assignee: Manchester Tank & Equipment Co., Franklin, TN (US)

(21) Appl. No.: 11/500,070

(22) Filed: Aug. 7, 2006

(51) Int. Cl. B62D 33/00

(52) U.S. Cl. 220/562

(57) ABSTRACT

A fuel cylinder for use in fueling vapor-powered machines and devices is claimed. The fuel cylinder contains a fuel vapor withdrawal pipe that bends upward towards the top edge of the cylinder when the cylinder is in its position of use, for example, the horizontal position if the tank is used horizontally. A liquid splash guard surrounds the inlet of the fuel vapor withdrawal pipe to protect the inlet from splashing of liquid propane in the cylinder. A brace connects to the fuel vapor withdrawal pipe to stabilize the fuel pipe during high vibration use. In one embodiment, the splash guard and brace are welded to the internal surface of a joggle in the rim of the upper head portion of the cylinder before the upper head portion and lower head portion of the cylinder are mated and welded together.

### FIELD OF THE INVENTION

The present invention relates generally to the field of pressurized fuel cylinders, and more particularly to means for preventing splashing of liquid into the vapor withdrawal pipe and for stabilizing the pipe.

### BACKGROUND OF THE INVENTION

Propane gas is becoming known as an attractive alternative to the use of conventional gasoline to fuel lawnmowers and other devices. Using propane tanks for lawnmowers eliminates the spillage associated with gasoline use and lessens harmful vapor releases. Propane versions of lawnmowers have been found to significantly reduce ozone-destroying emissions.

Propane gas cylinders or tanks are generally made from lightweight metals such as aluminum, but may also be made of steel or composite material. Because the cylinders are typically laid on their sides when positioned on the lawnmower, a pipe, runs from the service valve coupling at the top of the cylinder into the interior of the cylinder, and has a bend formed in it to position the open end of the pipe adjacent to the side of the cylinder at or near its uppermost point. This allows the propane vapor enter the pipe and exit through the service valve.

A significant problem exists in conventional gas cylinders with internal pipes for withdrawing liquid or gas, in that, due to the long lever arm presented by the pipe, vibrations of the pipe can result in significant stresses on the connection of the pipe to the service valve coupling. As a result, the pipe can develop fatigue cracks at the point where it is internally threaded into the service valve coupling. It would be desirable to have at least one brace inside the tank to support the vapor withdrawal pipe to prevent breaking of the pipe, especially in a vibration-prone environment.

In addition, because the bottom portion of the tank contains liquid fuel, it is important that means be employed to reduce the possibility that liquid fuel splashes into the vapor withdrawal pipe. In prior art uses of horizontal propane tanks in other vehicles, such as in recreational vehicles, the possibility of propane splashes is lessened by the fact that the vehicle is not generally in motion when the propane tank is in use. When horizontal propane tanks are used to fuel moving vehicles, such as lawnmowers, however, the tanks can be expected to operate in uneven or rough terrain in which sloshing and splashing of propane into the vapor withdrawal pipe could be a problem. It would therefore be desirable to have a means for reducing the possibility of splashing liquid entering into the vapor withdrawal pipe of a horizontal propane tank.

U.S. Pat. No. 5,105,996 (“the '996 patent”) addresses the problem of providing support for a liquid propane fuel pipe inside a horizontal propane cylinder. This prior art invention employs a cylinder made from a top section including a “joggle lip” which mates with the substantially straight rim lip of the cylinder bottom section. A brace member is welded to the joggle. The brace member includes a pair of spaced tines which are spaced apart to allow the liquid pipe to be fitted between the tines. The liquid pipe is secured to the brace prior to assembly of the top and bottom cylinder sections by fitting the pipe between the tines and then crimping the tines together to clamp the pipe in the brace. Once the pipe is secured within the brace, the top and bottom head sections are welded together to form the cylinder. The invention disclosed in the '996 patent thus addresses the problem of providing bracing for a liquid propane fuel pipe, but does not address the problems peculiar to the use of a horizontal propane tank with an internal vapor fuel pipe put to use in an operating environment which would cause splashing of liquid fuel. Further, the '996 patent does not address the need to protect the inlet of the vapor fuel pipe from splashing of liquid propane.

### SUMMARY OF THE INVENTION

It is an object of the present invention to provide a pressurized fuel cylinder for supplying fuel vapor to devices that may be operating in rough terrain and therefore be subjected to substantial jolts and vibrations.

It is another object of the present invention to provide a support apparatus for the vapor fuel withdrawal pipe of a fuel cylinder.

It is yet another object of the present invention to provide a means for reducing the possibility of liquid fuel splashing into the vapor fuel withdrawal pipe inlet.

The present invention achieves these objectives by providing a fuel cylinder with a vapor fuel withdrawal pipe that is supported in one or more places by internal bracing and in which a liquid splash guard protects the inlet of the vapor fuel withdrawal pipe from splashing fuel.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### DESCRIPTION OF THE DRAWINGS

FIG. 1 is a frontal, partially broken-away view of a gas cylinder employing a brace and splash guard in accordance with one embodiment of the present invention.

FIG. 2 is a cross-sectional view of the cylinder of FIG. 1, taken along line 2-2 of FIG. 1, showing a top view of the brace securing the vapor fuel pipe and the splash guard.

FIG. 3 is a cross-sectional view of one embodiment of the invention taken along line 3-3 of FIG. 2, showing the weld joints securing the brace to the top head joggle lip.

FIG. 4 is a partial perspective view of one embodiment of the top head section showing the vapor fuel pipe, the brace, and the splash guard.

FIG. 5 is a partial broken-away view of one embodiment of the brace, showing the brace tines in further detail.

FIG. 6 is a front view of one embodiment of the splash guard, before it is welded into place.

Repeat use of reference characters throughout the present specification and appended drawings is intended to represent the same or analogous features or elements of the invention.

### DETAILED DESCRIPTION

The present invention and its advantages are best understood by referring to the drawings. The elements of the drawings are not necessarily to scale, emphasis instead being placed upon clearly illustrating the principles of the invention.

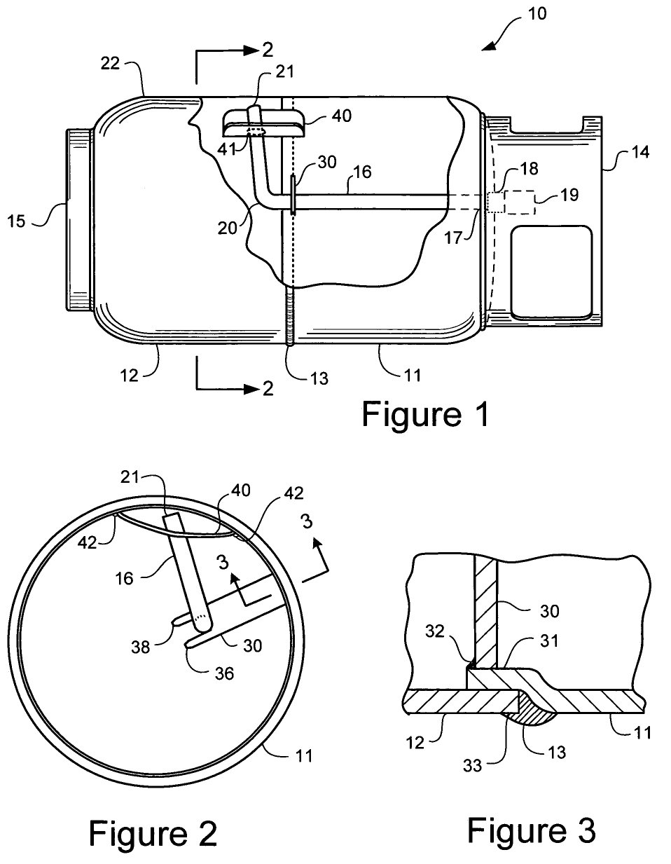

FIG. 1 illustrates one embodiment of a horizontal fuel gas cylinder 10 that may be used on a propane-powered lawnmower or other gas fuel-powered device. The cylinder 10 is made up of a “top” head section 11 and a “bottom” head section 12, which sections are secured together by a circumferential weld joint 13 to form a pressure vessel for containing fuel. (Note that the use of “top” and “bottom” head sections refers to the positioning of the cylinder in its traditional orientation, which is the orientation used for filling the cylinder, and not in its horizontal position, i.e., the position of its use.) Both the top head and the bottom head sections may be fabricated from aluminum or aluminum alloy to minimize the weight of the cylinder and to resist corrosion, though other materials could be used as well, such as steel or composite materials. In this embodiment, a guard or collar 14 is welded to the top head 11 in the conventional manner, and a foot ring 15 is welded to the bottom of the bottom head section 12.

In another embodiment of the invention, the cylinder is made of a composite material. In the composite embodiment, the head sections are connected together with adhesive.

Referring to FIG. 1, the cylinder 10 also comprises a pipe 16 contained within the cylinder 10. The pipe 16 is made of steel in one embodiment, though other materials could be employed, such as aluminum or plastic. In one embodiment, the pipe 16 is a ⅜ inch steel NPS pipe. One end 17 of the pipe 16 is threaded into a coupler 18 which in turn connects to a service valve 19. The valve 19 can be used to connect to an engine to provide the fuel vapor for engine operation. The pipe 16 has a bend 20 formed in it to bring the pipe's “open” end 21 adjacent to the side 22 of the bottom head section 12. In operation, the cylinder 10 is laid horizontally on its side as shown in FIG. 1, and oriented so that the pipe end 21 is at or near the uppermost point in the cylinder 10.

In the conventional manner, the cylinder 10 further includes additional fittings, such as a fill valve, a fill coupling, a float valve to indicate the fuel level and a pressure relief valve. These additional fittings are not illustrated herein.

To relieve the strain on the pipe 16 due to its long lever arm and the vibration experienced during operation of the lawnmower, a brace 30 is included to secure the pipe in accordance with the present invention. For aluminum cylinders, the brace 30 may be made of ⅛ inch thick aluminum, and in one embodiment is made of 6061-T6 aluminum alloy. As illustrated in FIG. 2, one embodiment of the brace 30 defines two protruding tines 36 and 38, which are spaced apart by a sufficient distance (prior to assembly with the pipe 16) to just allow the pipe 16 to be fitted between the tines. It is desirable to provide a slot dimension between the tines which is only slightly larger than the outer dimension of the pipe 16, so that the pipe fits tightly between the tines. This facilitates the clamping of the pipe tightly between the tines, so that the tine compression or crimping is not required to do all the work of securing the pipe in place.

As is better illustrated in FIG. 3, in one embodiment a joggle 31 is formed in the top head 11, and the bottom head 12 is formed with a straight rim 33. This arrangement permits the brace 30 to be welded to the joggle 31 of the top head 11 prior to the mating of the top and bottom head sections 11 and 12. The pipe 16 can then be fitted between the tines 36 and 38 of the brace 30 prior to assembling the top and bottom heads 11 and 12, and the tines squeezed together to secure the pipe 16 in place, as illustrated in FIGS. 2, 4 and 5. It will be appreciated that the tines 36 and 38 permit mechanical engagement with the pipe 16 by crimping the tines together into contact with the pipe. In this embodiment, because the brace is typically aluminum, and the pipe is steel, welding the brace 30 to the pipe 16 would be difficult due to the dissimilar materials.

As illustrated in FIG. 3, the brace 30 is welded to the joggle 31 of the top head section 11 via weld 32. In one embodiment illustrated herein, the brace 30 is welded to the joggle 31 by gas tungsten arc welding. For an aluminum cylinder of one embodiment, the welding filler wire found particularly well suited to the purpose for welding the 6061-T6 aluminum brace 30 to the joggle of 5154 aluminum is 4043 aluminum alloy filler wire. This particular filler wire is compatible with the two aluminum alloys, the 6061-T6 and the 5154, yet is a ductile material which provides a strong bond between the brace and the joggle. It is important that good welding techniques be employed to weld the brace to the joggle, such as welding to the ends of the brace and having an ample supply of the filler wire, so that the weld joint is not starved for filler during the welding process, and allowing the weld to spill over slightly at the brace ends. Such good welding techniques should be employed to prevent cracking of the weld due to the vibration experienced during operation of the lawnmower or other device.

Advantages of the brace 30 described above include the securing of the pipe 16 against vibration, thereby reducing the stress on the pipe and reducing stress failure rates, while fulfilling the requirement (applicable to metal cylinders) that no welding can be done to the straight sides of the cylinder. Further, the brace secures the pipe in a rugged and inexpensive manner even when the pipe and the brace are of dissimilar materials which cannot readily be welded together. While the brace disclosed herein is clamped onto the pipe by crimping the tines, and such method is particularly advantageous because of its simplicity, low cost and ruggedness, other mechanical means of connecting the brace to the pipe could alternatively be employed, such as inserting the pipe through a hole in the brace element. In embodiments of the invention in which the cylinder is fabricated from composite materials, the brace is glued to the inner surface of the cylinder rather than welded.

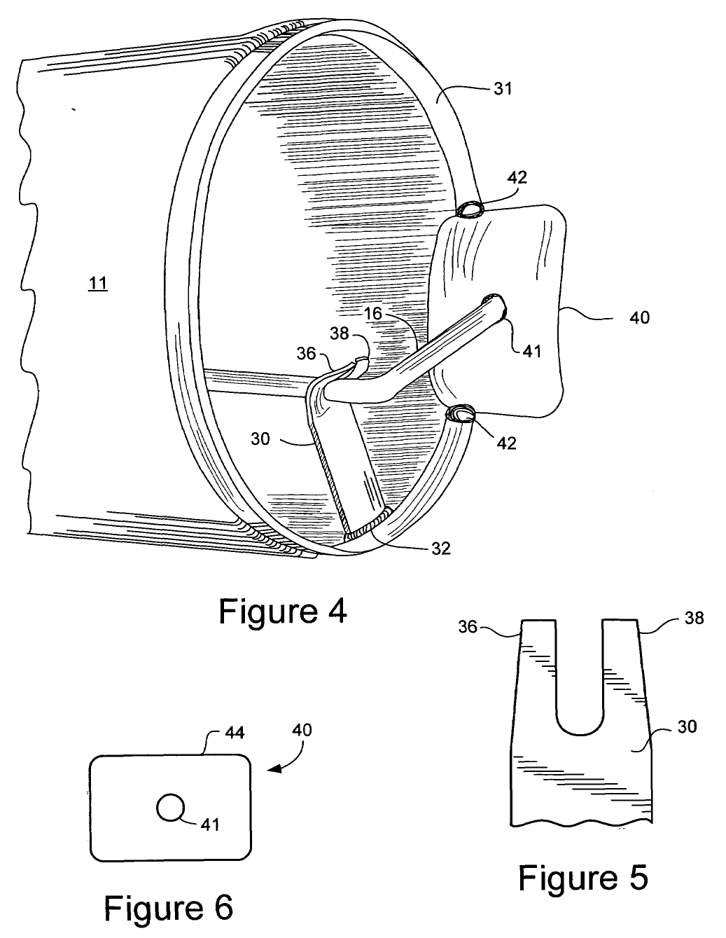

As illustrated in FIGS. 1, 2, and 4, the cylinder 10 includes splash guard 40, which is attached to the interior surface of joggle 31 of the top head section 11 as shown in FIGS. 2 and 4. The attachment of the splash guard, accomplished for metal cylinders by welding of the splash guard 40 to the joggle 31 of the top head 11, takes place prior to the mating of the top and bottom head sections 11 and 12. In one embodiment, the splash guard 40, further illustrated in FIG. 6, is a roughly rectangular or oblong aluminum sheet 44 containing aperture 41. Although the aperature is illustrated in FIG. 6 as a round hole, other shapes of apertures, such as oval or slotted, are also within the scope of the present invention. Further, other shapes of splash guards, such as circular or oval, are possible without departing from the scope of the present invention.

In the embodiment illustrated in FIG. 2, the sheet 44 is bent or curved as shown and fitted over the pipe 16 in such a manner that the pipe 16 is fed through the aperture 41 of the splash guard 40. In one embodiment, the splash guard 40 is welded to the joggle 31 via two welds 42 at the distal ends of the splash guard 40. In composite cylinders, the splash guard is attached to the interior surface of the cylinder via adhesive.

After the brace 30, pipe 16 and splash guard 40 are installed to the top head section 11, as described herein, the top head section 11 is mated to the bottom section 12 in the conventional manner. In one embodiment, the completed fuel cylinder is approximately one foot in inside diameter by about twenty-eight (28) inches in length.

Although the illustrated embodiment is a fuel cylinder designed for horizontal use, other orientations and shapes of fuel tanks could also employ the present invention, provided that the tanks have a fuel vapor withdrawal pipe internal to the cylinder.

This invention may be provided in other specific forms and embodiments without departing from the essential characteristics as described herein. The embodiment described is to be considered in all aspects as illustrative only and not restrictive in any manner.

As described above and shown in the associated drawings and exhibits, the present invention comprises an improved pressurized fuel cylinder. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A fuel tank comprising
liquid fuel;
an internal fuel vapor pipe with an inlet positioned above the fuel when the tank is in its position of use;
a support brace member for supporting the fuel vapor pipe;
a splash guard for deflecting the liquid fuel from entering the fuel vapor pipe inlet.

2. The fuel tank of claim 1, further comprising a top head section and a bottom head section connected together.

3. The fuel tank of claim 2, wherein the top head section comprises a joggle lip which mates with and is welded to a substantially straight rim of the bottom head section and wherein the support brace member and splash guard are welded to the interior surface of the joggle lip.

4. The fuel cylinder of claim 2, wherein the top and bottom head sections are manufactured from a composite material, and wherein the top and bottom head sections are connected together with adhesive.

5. The fuel cylinder of claim 4, wherein the fuel vapor pipe is plastic.

6. A fuel cylinder for horizontal use, comprising:
a top head section and a bottom head section welded together, the top head section comprising
a joggle lip which mates with a substantially straight rim of the bottom head section;
a vapor pipe inside the cylinder extending from an outlet end in the top portion of the top head section to an open inlet end adjacent to the cylinder's inside wall;
a support brace member welded to the interior surface of the joggle lip for supporting the vapor pipe against vibration;
a splash guard welded to the interior surface of the joggle lip for deflecting liquid fuel from the inlet of the vapor pipe.

7. The fuel cylinder of claim 6, wherein the top and bottom head sections, brace member, and splash guard are manufactured from aluminum.

8. The fuel cylinder of claim 6, wherein the top and bottom head sections, brace member, and splash guard are manufactured from steel.

9. The fuel cylinder of claim 6, wherein the vapor pipe is steel.

10. The fuel cylinder of claim 6, wherein the brace member comprises first and second tines separated by a distance sufficient to receive the pipe therebetween, the tines being thereafter crimped toward each other to secure the pipe therebetween prior to the welding of the top and bottom head sections.

11. The fuel cylinder of claim 6, wherein the splash guard surrounds the steel vapor pipe near its open inlet end.

12. The fuel cylinder of claim 6, wherein the splash guard comprises a curved oblong sheet of aluminum with an aperture therein through which the vapor pipe inlet end extends.

13. The fuel cylinder of claim 12, wherein the splash guard is welded to interior surface of the joggle lip in two places at distal ends of the splash guard.

14. The fuel cylinder of claim 6, wherein the splash guard comprises aluminum with a thickness of about ⅛ inch.

15. A fuel cylinder for horizontal use, comprising:
an aluminum top head section, comprising a joggle lip formed therein;
an aluminum bottom head section, comprising a substantially straight rim, the rim and the joggle lip sized to mate together and permit welding of the top and bottom head sections together during the construction of the cylinder;
a steel pipe having first and second ends, the first end being secured to a coupler in the top head section and an open second end being disposed after assembly of the cylinder adjacent an interior side surface of the cylinder, so that when the cylinder is disposed on its side and positioned so that the second end of the pipe is adjacent the uppermost side of the cylinder, fuel vapor may be withdrawn from the cylinder; and
a splash guard for preventing the splashing of liquid fuel into the second open end of the steel pipe, the splash guard welded to the joggle lip of the top head section prior to fitting and welding of the top head and bottom head sections together.

16. The cylinder of claim 15, further comprising means for supporting the steel pipe against vibrations, the means comprising an aluminum brace member welded to the joggle lip of the top head section and means for mechanically securing the steel pipe to the brace member, the supporting means further characterized in that the steel pipe may be secured to the coupler and by the supporting means prior to fitting the top head and bottom head sections together and welding the sections together, thereby easing the assembly of the cylinder.

17. The cylinder of claim 16, wherein the brace member comprises first and second tines separated by a distance about equal to the outer dimension of the steel pipe, and the securing means comprises the tines being placed in a crimped position after the pipe has been fitted between the tines.

18. The cylinder of claim 17 wherein the brace member is fabricated of an aluminum alloy approximately ⅛ inch thick.

19. The cylinder of claim 16 wherein the top and bottom head sections are made of 5154 aluminum alloy, the brace member and splash guard are made of 6061-T6 aluminum alloy, and are welded to the joggle lip by a gas tungsten arc welding process using filler wire of 4043 aluminum alloy.

20. The fuel cylinder of claim 15, wherein the splash guard surrounds the steel vapor pipe near its open inlet end.

21. The fuel cylinder of claim 15, wherein the splash guard comprises a curved oblong sheet of aluminum with a whole therein through which the steel pipe open end extends.

22. The fuel cylinder of claim 15, wherein the splash guard is welded to interior surface of the joggle lip in two places at distal ends of the splash guard.

23. The fuel cylinder of claim 15, wherein the splash guard comprises ⅛ inch thick aluminum.
